(19) United States
(12) Patent Application Publication
(10) Pub. No.: US 2002/0136229 A1
(43) Pub. Date: Sep. 26, 2002

(54) Non-blocking crossbar and method of operation thereof

(75) Inventors: David B. Kramer, Austin, TX (US); Michael A. Roche, Austin, TX (US); David P. Sonnier, Austin, TX (US)

Correspondence Address: HITT GAINES & BOISBRUN P.C., P.O. BOX 832570, RICHARDSON, TX, 75083, US

(73) Assignee: Lucent Technologies, Inc., Murray Hill, NJ (US)

(21) Appl. No.: 10/044,185

(22) Filed: Jan. 9, 2002

Related U.S. Application Data
(60) Provisional application No. 60/260,428, filed on Jan. 9, 2001.

(51) Int. Cl. H04L 12/28; H04B 7/212

(52) U.S. Cl. 370/412; 370/444

(57) ABSTRACT

A non-blocking crossbar for packet based networks and a method of operation thereof. In one embodiment, the non-blocking crossbar includes: (1) n inputs, n numbering at least two, (2) n outputs, each of the outputs having a destination first-in, first-out buffer (FIFO) and n crossbar FIFOs interposing corresponding ones of the n inputs and the destination FIFO, and (3) a scheduler configured to cause a packet to be transmitted from one of the inputs toward one of the outputs only when both the destination FIFO associated therewith and an interposing one of the crossbar FIFOs are available to contain the packet.

### CROSS-REFERENCE TO PROVISIONAL APPLICATION

This application claims the benefit of U.S. Provisional Application No. 60/260,428 titled “FOUR CHANNEL GIGABIT ETHERNET ARCHITECTURE” to Roger N. Bailey, et al., filed on Jan. 9, 2001, which is commonly assigned with the present invention and incorporated herein by reference as if reproduced herein in its entirety.

### CROSS-REFERENCE TO RELATED APPLICATIONS

This application is related to U.S. patent application Ser. No. ______, filed Jan. 9, 2002 and titled “A HEAD OF LINE BLOCKAGE AVOIDANCE SYSTEM AND METHOD OF OPERATION THEREOF” to David P. Sonnier. The above-listed application is commonly assigned and co-pending with the present invention and is incorporated herein by reference as if reproduced herein in its entirety.

### TECHNICAL FIELD OF THE INVENTION

The present invention is directed, in general, to network packet systems and, more specifically, to a non-blocking crossbar and method of operating the same.

### BACKGROUND OF THE INVENTION

Communications networks are currently undergoing a revolution brought about by the explosive growth of Internet traffic and by the increasing demand for real-time information being delivered to a diversity of locations employing multiple protocols. Many situations require the ability to transfer large amounts of data across geographical boundaries with increasing speed and accuracy. However, with the increasing size and complexity of the data that is currently being transferred, maintaining the speed and accuracy is becoming increasingly difficult.

Early communications networks consisted of the same type of network or networks that employed the same network protocol. Soon thereafter, multiple communications networks consisting of different network protocols and/or different transmission mediums where connected together. The network processing systems that interfaced between these multiple communications networks had to convert between different protocols and accommodate the timing and transmission requirements of each of the different transmission mediums.

At first, the transmission speeds of the communications networks were relatively slow and the network processing systems could keep up with the traffic. Soon thereafter, faster communications networks were developed and the network processing system encountered problems with connecting networks having different transmission speeds. More specifically, the network processing systems typically employ a crossbar to send one packet from one network to another network. However, since the packets on each network may be of different lengths, the crossbar may encounter contention for one or more of the outputs of the crossbar. This problem is typically called blocking.

Blocking typically occurs when one input is unable or blocked from sending a packet to an output. For example, a first input of the crossbar is sending a short packet to a first output. Also, a second input is sending a long packet to a second output. When the first input finishes and needs to send a packet to the second output. The first input is blocked because the second input is still sending the long packet to the second output. The first input has to wait until the second input has finished sending its long packet before it can transmit to the second output. In view of the ever increasing demand for higher transmission speeds these blocking problems are highly undesirable.

Accordingly, what is needed in the art is a system to overcome the deficiencies of the prior art.

### SUMMARY OF THE INVENTION

To address the above-discussed deficiencies of the prior art, the present invention provides a non-blocking crossbar and a method of operating the same. In one embodiment, the non-blocking crossbar includes n inputs, n numbering at least two, and n outputs. Each of the outputs having a destination first-in, first-out buffer (FIFO) and n crossbar FIFOs interposing corresponding ones of the n inputs and the destination FIFO. Additionally, the non-blocking crossbar includes a scheduler configured to cause a packet to be transmitted from one of the inputs toward one of the outputs only when both the destination FIFO associated therewith and an interposing one of the crossbar FIFOs are available to contain the packet.

In another embodiment, the present invention provides a method of operating a non-blocking crossbar, the method includes: (1) employing n inputs, n numbering at least two, (2) employing n outputs, each of the outputs having a destination first-in, first-out buffer (FIFO) and n crossbar FIFOs interposing corresponding ones of the n inputs and the destination FIFO, and (3) scheduling a packet to be transmitted from one of the inputs toward one of the outputs only when both the destination FIFO associated therewith and an interposing one of the crossbar FIFOs are available to contain the packet.

The present invention also provides, in one embodiment, a multi-channel network line card for packet based networks that includes: (1) n physical interfaces, n numbering at least three, (2) n network processors that convert a packet between protocols, each of the network processors coupled to corresponding ones of the n physical interfaces, and (3) a non-blocking crossbar coupled to the network processors and the physical interfaces. The non-blocking crossbar includes: (1) n inputs that receive the packet from corresponding ones of the n network processors, (2) n outputs that transmit the packet to corresponding ones of the n physical interfaces, each of the outputs having a destination first-in, first-out buffer (FIFO) and n crossbar FIFOs interposing corresponding ones of the n inputs and the destination FIFO, and (3) a scheduler that causes the packet to be transmitted from one of the inputs toward one of the outputs only when both the destination FIFO associated therewith and an interposing one of the crossbar FIFOs are available to contain the packet.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of a multi-channel network line card for packet based networks constructed in accordance with the principles of the present invention;

FIG. 2 illustrates a block diagram of an embodiment of a non-blocking crossbar constructed in accordance with the principles of the present invention; and

FIG. 3 illustrates a flow diagram of an embodiment of a method of operating a non-blocking crossbar constructed in accordance with the principles of the present invention.

### DETAILED DESCRIPTION

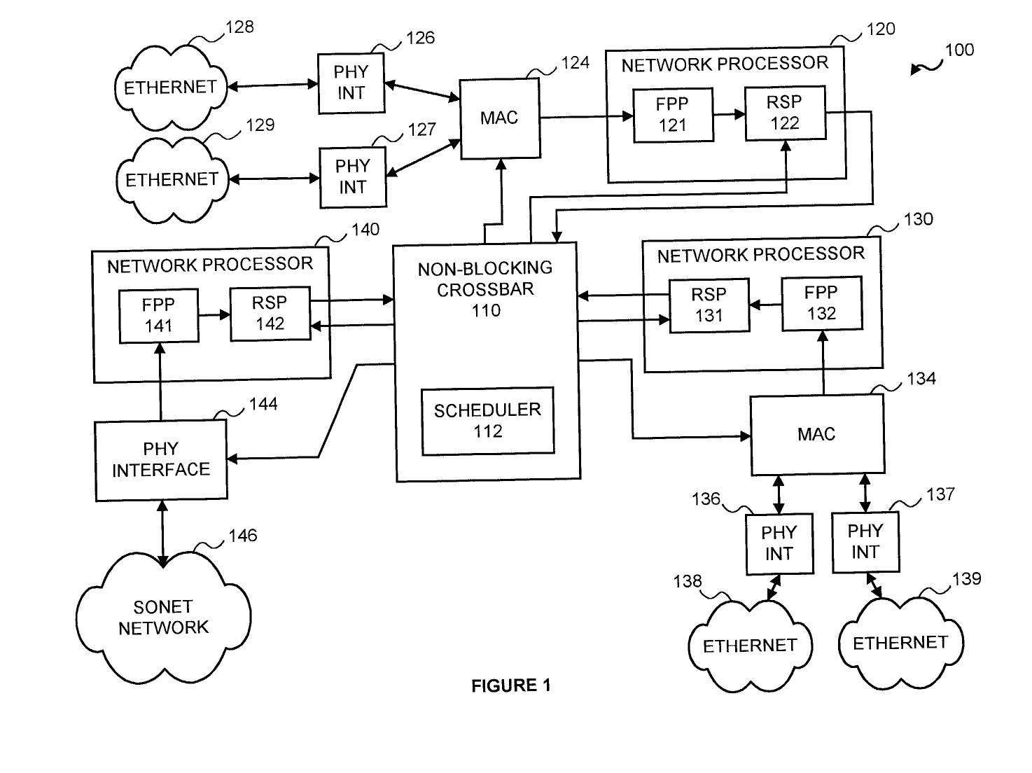

Referring initially to FIG. 1, illustrated is a block diagram of an embodiment of a multi-channel network line card for packet-based networks, generally designated 100, constructed in accordance with the principles of the present invention. The multi-channel network line card 100 is generally designed to transport packets between multiple networks. The multi-channel network line card 100 may also perform conversion between different protocols. The networks may be of different types, employ different transmission mediums, different communication speeds, or a combination thereof. In the illustrated embodiment, the multi-channel network line card 100 transports packet between four Gigabit ETHERNET networks 128, 129, 138, 139 and a Synchronous Optical Network (SONET) network 146. Of course, however, the present invention is not limited to the types of networks listed above. In other embodiments, the present invention may transport packets between other types of networks and may employ any number of networks.

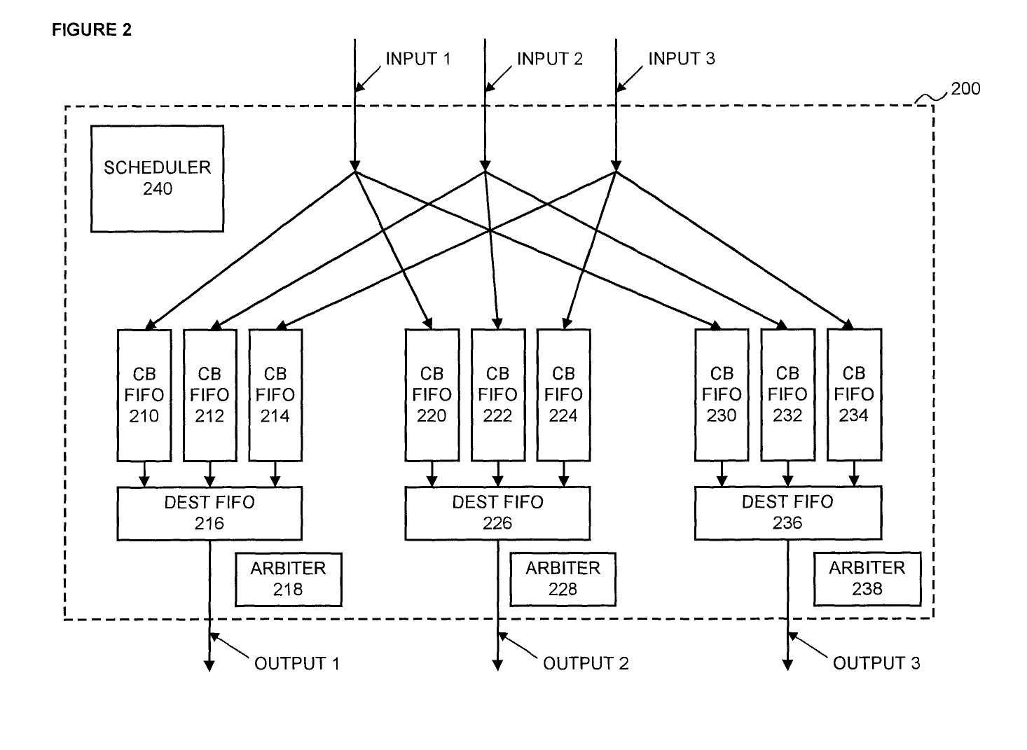

The multi-channel network line card 100 includes a non-blocking crossbar 110 that is configured to transmit or transport packets between multiple inputs and multiple outputs. The non-blocking crossbar 110 performs functions similar to typical network crossbars, but is configured to transmit packets from multiple networks in a non-blocking manner. The non-blocking crossbar 110 may also perform additional functions in addition to the basic functions of a typical crossbar. For purposes of the present invention, the phrase “configured to” means that the device, the system or the subsystem includes the necessary software, hardware, firmware or a combination thereof to accomplish the stated task. The non-blocking crossbar 110 also includes a scheduler 112 that is configured to cause a packet to be transmitted from one of the crossbar inputs toward one of the crossbar outputs only when there is no contention. The non-blocking crossbar 110 and the scheduler 112 are discussed in more detail in FIG. 2.

In the illustrated embodiment, a first input of the non-blocking crossbar 110 is coupled to a first network processor 120 and a first output of the non-blocking crossbar 110 is coupled to a media access controller (MAC) 124. The MAC 124 is also coupled to first and second physical interfaces 126, 127, which in turn are coupled to corresponding Gigabit ETHERNET networks 128, 129. The first and second physical interfaces 126, 127 may be conventional network physical interfaces that interface with the Gigabit ETHERNET networks 128, 129 and the MAC 124.

The MAC 124, in one embodiment, is a conventional two channel ETHERNET media access controller. In another embodiment, a physical interface may include a MAC or any other type of network controller. The MAC 124 receives packets from the first and second physical interfaces 126, 127 and transmits the packets to first network processor 120. The MAC 124 also receives packets from the first output of the non-blocking crossbar 110 and transmits the packets to the appropriate first and/or second physical interfaces 126, 127.

The first network processor 120 is configured to convert a packet between protocols, classify the packet and may perform packet modification. The first network processor 120, in the one embodiment, may include a fast pattern processor (FPP) 121 and a routing switch processor (RSP) 122. The FPP 121 is configured to receive packets from the first and second physical interfaces 126, 127 via the MAC 124, analyze and classify the packet. The FPP 121 may also determine a priority of the packet based on a field within the packet or based on a type of the packet's contents. The RSP 122 is configured to receive the classified packet from the FPP 121, perform traffic management and convert the packet to the appropriate protocol if required. In the illustrated embodiment, the RSP 122 may convert the packet for transmission to the SONET network 146 or to any of the Gigabit ETHERNET networks 128, 129, 138, 139. Of course, however, the RSP 122 is not limited to converting between the networks listed above. In other embodiments, the RSP 122 may convert the packet to any type of protocol. Additionally, the first network processor 120 may also segment the packet into smaller blocks for processing by the non-blocking crossbar 110.

The RSP 122 also sends the converted packet to the non-blocking crossbar 110 for transmission to a specified output. The scheduler 112, in one embodiment, communicates with the RSP 122 to indicate when the RSP 122 may send the next packet. The scheduler 112 may also receive a priority associated with the packet from the RSP 122 to be used when the scheduler 112 schedules packets to be transmitted from the inputs toward the outputs. In another embodiment, the scheduler 112 may assign a priority to the packet and inform the RSP 122. Of course, however, other methods of assigning a priority to packet may be used.

Additional background information concerning the FPP and the RSP are discussed in U.S. patent application Ser. No. 9/798,472, titled “A VIRTUAL REASSEMBLY SYSTEM AND METHOD OF OPERATION THEREOF,” and in U.S. patent application Ser. No. 9/822,655, titled “A VIRTUAL SEGMENTATION SYSTEM AND METHOD OF OPERATION THEREOF.” Both of the above-listed applications are incorporated herein by reference as if reproduced herein in their entirety.

A second input of the non-blocking crossbar 110 is coupled to a second network processor 130 and a second output of the non-blocking crossbar 110 is coupled to a MAC 134. The MAC 134 is also coupled to third and fourth physical interfaces 136, 137, which in turn are coupled to corresponding Gigabit ETHERNET networks 138, 139. The third and fourth physical interfaces 136, 137 may be conventional network physical interfaces that interface with the Gigabit ETHERNET networks 138, 139 and the MAC 134.

The MAC 134, in one embodiment, is a conventional two channel ETHERNET media access controller. In another embodiment, a physical interface may include a MAC or any other type of network controller. The MAC 134 receives packets from the third and fourth physical interfaces 136, 137 and transmits the packets to second network processor 130. The MAC 134 also receives packets from the second output of the non-blocking crossbar 110 and transmits the packets to the appropriate third and/or fourth physical interfaces 136, 137.

The second network processor 130 has the same capabilities and performs the same types of functions as the first network processor 120. The second network processor 130, in the one embodiment, may include an FPP 131 and an RSP 132. The FPP 131 is configured to receive packets from the third and fourth physical interfaces 136, 137 via the MAC 134. The RSP 132 is configured to receive packets from the FPP 131 and transmit the packets to the second input of the non-blocking crossbar 110. The FPP 131 and the RSP 132 have the same capabilities and perform the same types of functions as the FPP 121 and the RSP 122 respectively. Additionally, both the second network processor 130 and the RSP 132 have the same capabilities and can perform the same types of functions as described above for the first network processor 120, the RSP 122 and interfacing with the scheduler 112.

A third input of the non-blocking crossbar 110 is coupled to a third network processor 140 and a third output of the non-blocking crossbar 110 is coupled to a physical interface 144. The physical interface 144 is also coupled to the SONET network 146. The physical interface 144 may be a conventional network physical interface that interfaces with the SONET network 146. In another embodiment, the physical interface 144 may include a MAC or any other type of network controller. The physical interface 144 receives packets from the SONET network 146 and transmits the packets to third network processor 140. The physical interface 144 also receives packets from the third output of the non-blocking crossbar 110 and transmits the packets to the SONET network 146.

The third network processor 140 has the same capabilities and performs the same types of functions as the first network processor 120. The third network processor 140, in the one embodiment, may include an FPP 141 and an RSP 142. The FPP 141 is configured to receive packets from the physical interface 146. The RSP 142 is configured to receive packets from the FPP 141 and transmit the packets to the third input of the non-blocking crossbar 110. The FPP 141 and the RSP 142 have the same capabilities and perform the same types of functions as the FPP 121 and the RSP 122 respectively. Additionally, the third network processor 140 and the RSP 142 have the same capabilities and can perform the same types of functions as described above for the first network processor 120, the RSP 122 and interfacing with the scheduler 112.

Turning now to FIG. 2, illustrated is a block diagram of an embodiment of a non-blocking crossbar, generally designated 200, constructed in accordance with the principles of the present invention. The non-blocking crossbar 200, in one embodiment, may be employed in a multi-channel network line card similar to the one illustrated in FIG. 1. The non-blocking crossbar 200 is configured to transmit or transport packets between multiple inputs and multiple outputs. The non-blocking crossbar 200 performs functions similar to typical network crossbars, but is advantageously configured to transmit packets from multiple networks in a non-blocking manner. The non-blocking crossbar 200 may also perform additional functions in addition to the functions performed by the typical crossbar.

In the illustrated embodiment, the non-blocking crossbar 200 includes three inputs and three outputs. Each of the inputs is configured to receive packets from a network (or fabric) and may be coupled to network processors or physical interfaces similar to the ones illustrated in FIG. 1. Each of the inputs, in one embodiment, may also include a receive first-in-first-out buffer (FIFO) (not shown) that is configured to hold at least one packet received from the network. The receive FIFO may be used for rate decoupling. One skilled in the pertinent art is familiar with rate decoupling for networks. Although FIG. 2 illustrates an embodiment of the present invention with three inputs and outputs, it should be understood that the present invention is capable of operating and/or may be implemented with at least two inputs and outputs.

Each of the outputs transmits received packets to a destination network via a physical interface (not shown). The first output includes a destination FIFO 216 that is configured to hold at least one packet. The first output also includes three crossbar FIFOs 210, 212, 214 interposing corresponding ones of the inputs and the destination FIFO 216. The first crossbar FIFO 210 interposes the first input and the destination FIFO 216, and is configured to receive and hold at least one packet. The second crossbar FIFO 212 interposes the second input and the destination FIFO 216, and is configured to receive and hold at least one packet. The third crossbar FIFO 214 interposes the third input and the destination FIFO 216, and is configured to receive and hold at least one packet. Each output of the present invention advantageously employs a crossbar FIFO for each of the inputs as part of the non-blocking capability of the non-blocking crossbar 200. Although FIG. 2 illustrates an embodiment of the present invention with three crossbar FIFOs per output, it should be understood that the present invention is capable of operating and/or may be implemented with at least two inputs and outputs, where each output has at least two crossbar FIFOs.

The packets contained within the crossbar FIFOs 210, 212, 214 are selectively transmitted one at a time to the destination FIFO 216. The packet within the destination FIFO 216 is transmitted to the first output if the first output is available to receive the packet. Since each of the crossbar FIFOs 210, 212, 214 contain a complete packet, the destination FIFO 216 always has a complete packet to transmit and does not have to wait for a partial packet. In one embodiment, the first output may also include an output arbiter 218 that is configured to select one of the crossbar FIFOs 210, 212, 214 and transfer a packet therein to the destination FIFO 216. In a related embodiment, the output arbiter 218 is further configured to select one of the crossbar FIFOs 210, 212, 214 based upon a priority of the packets within the crossbar FIFOs 210, 212, 214. Of course, however, other methods of selecting which packets are to be transmitted are well within the broad scope of the present invention.

The second output of the non-blocking crossbar 200 includes a destination FIFO 226 and three crossbar FIFOs 220, 222, 224 interposing corresponding ones of the inputs and the destination FIFO 226. The third output of the non-blocking crossbar 200 includes a destination FIFO 236 and three crossbar FIFOs 230, 232, 234 interposing corresponding ones of the inputs and the destination FIFO 236. The second and third outputs contain identical types of elements that are configured in the same manner, have the same capabilities and perform the same types of functions as described above with the first output. In another embodiment, the second and third outputs may include output arbiters 228, 238, respectively, configured the same as the arbiter 218 and having the same capabilities and types of functions as the arbiter 218. The first, second and third outputs, however, may operate independently of each other and may have some variations depending upon the type of network the output is associated with.

The non-blocking crossbar 200 also includes a scheduler 240 configured to cause a packet to be transmitted from one of the inputs toward one of the outputs only when both the destination FIFO associated therewith and an interposing one of the crossbar FIFOs are available to contain the packet. For example, if a packet at the first input is to be transmitted to the second output, the scheduler 240 will first check to see if the crossbar FIFO 220 can contain the packet. The scheduler 240 also checks to see if the destination FIFO 226 can contain the packet. If both the crossbar FIFO 220 and the destination FIFO 226 can contain the packet, the scheduler 240 then causes the packet to be transmitted from the first input to the crossbar FIFO 220 of the second output. If the crossbar FIFO 220 or destination FIFO 226 is unavailable to contain the packet, the scheduler 240 may then determine if the first input has a packet that has the first output or the third output as its destination. If so, then the scheduler 240 performs the above described tests for the new output. In another embodiment, the scheduler 240 may also employ some type of flow control to reserve space for the entire packet in the crossbar and destination FIFOs upon determining availability in order to prevent others from obtaining all or part of the same space in the FIFOs.

Referring to the blocking example previously described, the first input is sending a short packet to the first output and the second input is sending a long packet to the second output. When the first input finishes transmitting the packet to the first output and needs to send a packet to the second output, the scheduler 240 determines if the crossbar FIFO associated with the first input and the destination FIFO for the second output can contain the packet. Since the whole packet is transferred to the crossbar FIFO before that packet is transmitted to the destination FIFO, the second input would still be transmitting its packet to an associated crossbar FIFO and the destination FIFO would be available. Thus, the crossbar FIFO associated with the first input and the destination FIFO are available to contain the first input's packet. The first input's packet could then be transmitted to the associate crossbar FIFO of the second output. Therefore, the first input is not blocked because the second input is still transmitting the long packet to its associated crossbar FIFO of the second output.

The use of a crossbar FIFO for each input within each output and the checking of both the crossbar FIFO associated with the input and destination FIFO allows a packet to be scheduled and not encounter contention for the output. Also, by the scheduler 240 checking if the input can transmit another packet to a different output if the desired output is unavailable will advantageously allow the non-blocking crossbar to maintain the bandwidth between the different networks.

The crossbar scheduler 240, in one embodiment, may select one of the inputs to process based upon a priority of the input. For example, one input may be more critical or it may be more important to maintain as much throughput as possible for that input. Therefore, that input may be assigned a higher priority in order to allow more packets to be processed for that input. In another embodiment, the crossbar scheduler 240 may select one of the outputs to process based upon a priority of the output. For example, the inputs may be scanned to determine which packets are to be sent to the output with the higher priority. Then, those inputs will be processed with a higher priority.

An example of a priority scheduling algorithm for a non-blocking crossbar, such as the one illustrated in FIG. 1, is listed in Table 2.1 below.

TABLE 2.1
The algorithm can be divided into 2 basic components. One component is concerned with
maintaining all the state described above. This is implemented as event driven state machines.
A natural way to describe these functions is to describe the state transformations that occur on
each event. The second major component is the scheduling algorithm proper. It uses all the
maintained state, and in addition, generates events that cause additional state changes to occur.
A Protocol Data Unit (PDU) is a unit of data transmitted for a particular protocol. A PDU may
also be called a packet.
PDU Enqueue
This event occurs every time an enqueue message is received from an RSP. This event can
happen up to 3 times per block time. The information available for this event is:
• RSP Which RSP this enqueue event is from.
• DEST Which DEST (output) this PDU is targeted at.
• PRI What priority queue is this PDU on.
• TIT The number of times to transmit for this PDU.
# Determine which crossbar port this' PDU is going to
xbar = xbarmap(DEST)
# This queue now has one more PDU on it, It is. also now active
qdepth[RSP] [DEST] [PRI]++
qactive[RSP] [DEST] [PRI] = 1
gany[RSP] [DEST] = 1
# Update the information about the. highest priority PDU going
to
# this DESTINATION from this RSP.
qhighest[RSP] [DEST] = PriorityEncode(qactive[rsp] [dest])
PDU Schedule
This event occurs every time the scheduler determines the next PDU to transmit from a
particular RSP. It can also happen up to 3 times per block time. The information available for
this event is:
• RSP Which RSP this enqueue event is from.
• DEST Which DEST this PDU is targeted at.
• PRI What priority queue is this PDU on.
• TTT The number of times to transmit for this PDU.
# Determine which crossbar port this PDU is going to
xbar = xbarmap(DEST)
# This queue now-has one less PDU on it.
# Update qactive, qhighest, qany
qdepth[RSP] [DEST] [PRI]−
qactive[RSP] [DEST] [PRI] = qdepth[RSP] [DEST] [PRI] != 0
qany[RSP] [DEST] = qactive[RSP] [DEST) != 0
# Update the information about the highest priority PDU going to
# this DESTINATION from this RSP.
qhighest[RSP] [DEST] = PriorityEncode(qactive[rsp] [dest])
# We have consumed some space in the specified destination FIFO
destfree[DEST] −= ttt
destavail[DEST] = destfree[DEST] >= PKTSTZE
# We have also consumed some space in the crossbar FIFO
xfree[RSP] [xbar] −= ttt
xavail[RSP] [xbar] = xfree[RSP] [xbar] >= PKTSIZE
# We now have some blocks which have been scheduled but not
# transmitted from the crossbar
sdepth[RSP] [xbar] [PRI] += ttt
sactive[RSP] [xbar] [PRI] = 1
shighest[RSP] [xbar] = PriorityEncode(sactive[RSP] [xbar])
Block Schedule
This event happens each time an RSP is instructed to transmit one block. This may happen once
per PDU, or many times per PDU, depending on the TTT of the PDU.

| | |
|---|---|
| • RSP | Which RSP block is being scheduled on |
| • DEST | Which destination |
| • PRI | Priority level of this schedule |

# Determine the crossbar port of interest
xbar = xbarmap[DEST]
# Push the priority of this block onto the appropriate sfifo.
# This will be used later to know which sdepth to decrement
push(sfifo[RSP] [xbar], pri)
XBAR FIFO Pull
This event happens every time an xbarpull signal is asserted. This can happen up to3 times per
block time.
• XBAR Which XBAR port this block is going to
• RSP Which RSP FIFO the block is being pulled from
#We have, one more available TTT in this crossbar FIFO
xfree[RSP] [XBAR]++
xavail[RSP] [XBAR) = xfree[RSP] [XBAR) >= PKTSTZE
# Determine what the priority of the block just pulled is.
# Update sdepth and things derived from sdepth.
pri = pop(sfifo[RSP] [XBAR])
sdepth[RSP] [XBAR] [pri]−−
sactive[RSP] [XBAR] [pri] = sdepth[RSP] [XBAR] [pri] != 0
shighest[RSP] [xbar] = PriorityEncode(sactive[RSP] [xbar])
# If this
Destination FIFO pull
This event happens whenever a destpull signal is asserted.
• DEST FIFO pulled from
# Update destfree & destavail
destfree[DEST]++
destavail[DEST] = destfree[DEST] >= PKTSIZE
Schedule Algorithm - Pick a destination port for each RSP
This state machine runs once per schedule period. It sequentially looks at all 3 RSPs, making a
destination, decision for each RSP. The arbitration used in this process is as follows:
• Some configured fraction of the time, we will do a RR across all the destinations that can be
scheduled.
• The rest of the time we will make a strict priority decision.
# Take a snapshot of destavail. As we pick destinations for an
# RSP, we clear the destavailtmp bit, this prevents us from
# scheduling two RSPs to the same destination in the same
# schedule period
destavailtmp = destavail
# We look at the RSPs in the following order, TDAT IF, ENET 0&1.
# Every other time we swap the order of ENET 0 & 1 so that they
# achieve round robin behavior.
for (all RSPs in the order described order) {

rsp = RSP we are currently working on
# The qany bits are organized so that they all the qany bits
# for a single RSP can be read in one clock
qanytmp = qany[rsp] [*]
# The qhighest bits are also organized so that they can all
# be read out in one clock
qhighesttmp = qhighest[rsp] [*]
# This is written as a loop, but may be done in combinatorial
# logic
for (desttmp in destinations) {

# if destavail is false or the appropriate xavail is
# false, clear qanytmp & qhighesttmp
if (!destavailtmp[desttmp] || !xavail[xbarmap(desttinp)]) {

qanytmp[desttmp] = 0
qhigbesttmp[desttmp] = 0

}

}
# Update the highest priority non backpressured destination
# we have to this xbar. This may be done in parallel
# combinatorial logic
xhighest[0] = max(qhighesttmp[0:15])
xhighest[1] = max(qhighesttmp[16:17])
xhighest[2] = max(qhighestfmp[18:19])
#Determine what the highest priority is from this RSP
highesttmp=max(qhighesttmp[0:19])
# If this RSP needs a PDU (it's about to finish the previous
# one)
if (RSP is ready to schedule && qanytmpr !=0) {

if (it's time to do a round robin schedule) {

# Pick a ready destination in a RR fashion
destport[rsp]=next RR dest out of those with qanytmp set

} else {

# This should use, a different RR state than the non
# priority one
destport[rsp]=next RR dest out of those with qanytmp set

&& qhighesttmp[dest] == highesttmp

}
# Clear destavailtmp for the destination we just picked.
# Pre-vent any later RSPs from selecting it
destavailtmp[destport[rsp]] = 0

} else {

destport[rsp] = NULL

}

Schedule Algorithm - Pick a destination port for each RSP
This happens in a separate state machine from the destination port selection. Here given the
destination port selected above (for each RSP) we will pick the actual priority to send. The
algorithm is similar. A configured amount of the time we do a straight RR, the rest of the time
we do a strict priority.
# Loop over all RSPs in the same order they we done above
for (rsp in “ALL RSPs in the order selected above”) {

if (destport[rsp] != NULL) {

qactivetmp = qactive[rsp] [destport[rsp] ]
if (it's time for a RR schedule) {

Schedule from a priority in qactivetmp in a RR fashion
This generates the PDU schedule event which causes
state updates described above

} else {

Schedule from the highest priority queue in qactivetmp
This generates the PDU schedule event which causes
state updates described above

}

}

}
Schedule Algorithm - Issue RSP ES events
Whenever a new PDU is scheduled, we know the RSP, the DEST and the PRI. From this we
can derive the queue number. In addition, we know the TTT since we read it out of the external
RAM. This logic generates TTT schedule requests to the specified RSP. Each schedule request
turns into a block schedule which causes state tracking as defined above. In additiion, when we
get to the end of the PDU, we trigger the scheduler state machine to pick a new PDU for this
RSP. This last process needs to have enough look ahead in the pipeline so that we can get the
new PDU in time.
XBAR Arbitration Determination
This works by determining for each crossbar target the highest priority traffic from each of the
RSPs that meets the following criteria:
• In the crossbar FIFO
• Scheduled, but in the RSP pipeline
• Queued in the RSP, but that is not backpressured.
These decision trees look more complicated than they really are, the basic decision is as follows:
• If the TDAT IF has the highest priority in it, it wins, so set bits 3:2 of the output

• If the two ENET ports tie, set bits 1:0 to 3 to indicate a tie
• Otherwise set bits 1:0 to indicate which ENET port is higher priority

• If the two ENET ports tie

• Set bits 3:0 of the output to 3 to indicate the highest pri is a tie between the ENETs
• Set bits 1:0 to 0 to indicate that port 0 loses

• One of the ENET ports won

• Set bits 3:0 to the winning ENET port
• If the TDAT IF port is at least as high as the other ENET port, set bits 1:0 to 0 indicate
the TDAT IF is second

• Otherwise, set bits 1:0 to the other ENET port.
# Determine XBAR arbitration

for (xbar in (0:21]) {

xhightmp[0] = max(xhighest[0] [xbar], shighest[0] [xbar])
xhightmp[1] = max(xhighest[1] [xbar], shighest[1] [xbar])
xhightmp[2] = max(xhighest[2] [xbar], shighest[2] [xbar])
hightmp = max(xhightmp)

if (xhightmp[0] == hightmp) {

# TDAT IF is at highest priority
xbarpri[xbar] [3:2] = 0
# See who comes in second
if (xhightmp[1] > xhightmp[2])

xbarpri[xbar] [1:0] = 1

else if (xhightmp[1] < xhightmp[2])

xbarpri[xbar] [1:0] = 2

else

xbarpri[xbar] [1:0] = 3

} else if (xhightmp[1] == xhightmp[2]) {

# The 2 ENET ports tie, set xbarpri to 3 to tell that to
# XBAR Port 0 must be last
xbarpri[xbar] [3:2] = 3
xbarpri[xbar] [1:0] = 0

} else if (xhightmp[1] > xhightmp[2]) {

# ENET 0 wins, must determine who came in second
xbarpri[xbar] [3:2] = 1
if (xhightmp[0] >= xhightmp[2])

xbarpri[xbar] [1:0] = 0

else

xbarpri[xbar] [1:0] = 2

}else {

# Enet 1 wins, must determine who came in second
xbarpri[xbar] [3:2] = 2
if (xhightmp[0] >= xhightmp[1])

xbarpri[xbar] [1:0] = 0

else

xbarpri[xbar] [1:0] = 1

}

}
xbarpri[xbar] [4] = “is it time for a xbar RR”

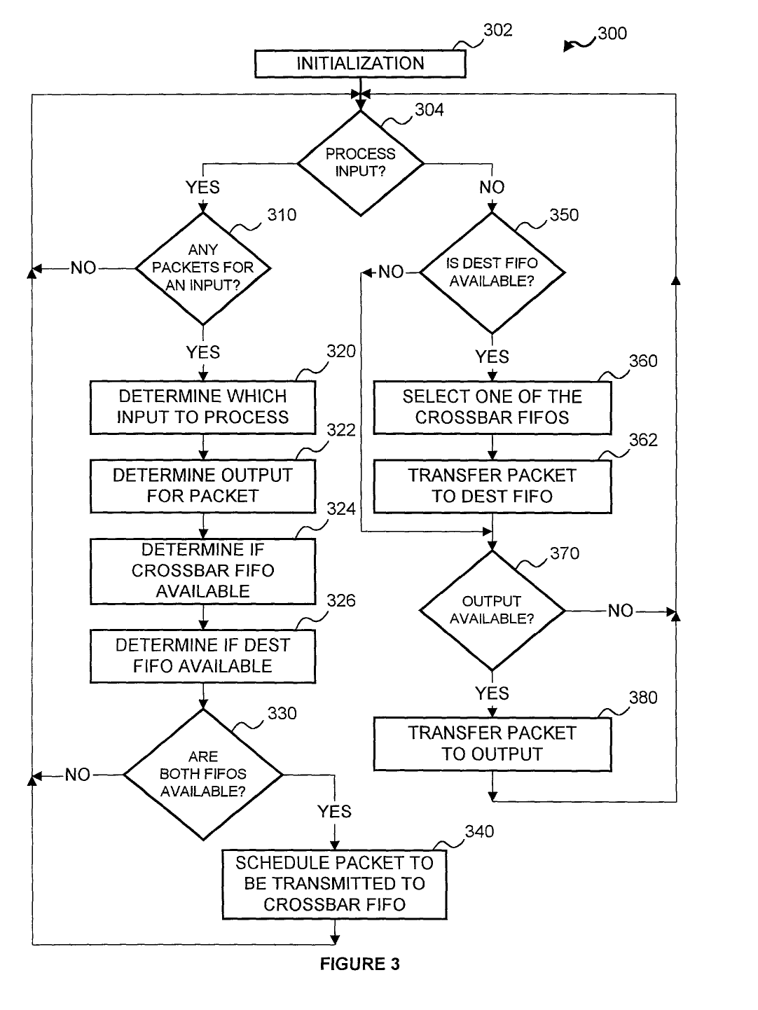

Turning now to FIG. 3, illustrated is a method of operating a non-blocking crossbar, generally designated 300, constructed according to the principles of the present invention. In FIG. 3, the method 300 first performs initialization in a step 302.

After initialization, the method 300 determines if it is to process an input or an output in a decisional step 304. If the method 300 is to process an input, the method 300 then determines if any of the inputs have any packets in a decisional step 310. If none of the inputs have a packet, the method 300 then returns to determine whether to process an input or process an output in the decisional step 304. If multiple inputs have a packet, the method 300 then determines which of the inputs to process in a step 320. In one embodiment, the method 300 may select one of the inputs based upon a priority of the input. In another embodiment, the method 300 may select one of the inputs by first selecting an output based on a priority thereof and then determining which of the inputs have a packet to be transmitted to that output. In yet another embodiment, the method 300 may select the input based on a priority of the packets contained therein. Of course, however, other methods of selecting an input or priority schemes are within the broad scope of the present invention.

Next, the method 300 determines which output the packet is to be transmitted to in a step 322. The method 300 may examine the contents of the packet or employ destination information associated with the packet to determine the appropriate output. The method 300 then determines if a crossbar FIFO of the output and associated with the input is available to contain the packet in a step 324. The method 300 also determines if the destination FIFO of the output is available to contain the packet in a step 326.

The method 300 then determines if both of the crossbar FIFO associated with the input and the destination FIFO of the output are available to contain the packet in a decisional step 330. If both the crossbar FIFO and the destination FIFO are available to contain the packet, then the method 300 schedules the packet to be transmitted to the output's crossbar FIFO that is associated with the input in a step 340. The method 300 then returns to determine whether to process an input or process an output in the decisional step 304.

If both the crossbar FIFO and the destination FIFO of the output are not available to contain the packet, the method 300 returns to determine whether to process an input or process an output in the decisional step 304. In another embodiment, the method 300 may instead determine if the input has a packet that may be transmitted to a different output. If so, the method 300 then determines if both of the new output's crossbar FIFO associated with that input and the destination FIFO is available to contain the new packet and schedules the packet as described in the steps 324-340.

If the method 300 determined not to process an input and to process an output in the decisional step 304, the method then determines if the destination FIFO of the output is available to receive a packet from one of the output's crossbar FIFOs in a decisional step 350. If the destination FIFO is available to receive a packet, the method 300 then selects one of the output's crossbar FIFOs in a step 360. In one embodiment, the method 300 selects one of the crossbar FIFOs based upon a priority of the packets contained within the crossbar FIFOs. The method 300 then transfers the packet from the selected crossbar FIFO to the destination FIFO of the output in a step 362.

If the method 300 determined that the output's destination FIFO is not available in the decisional step 350 or the method 300 transferred the packet to the destination FIFO in the step 362, the method then determines if the output is available to receive a packet in a decisional step 370. If the output is not available to receive a packet, the method 300 then returns to determine whether to process another input or process another output in the decisional step 304. If the output is available to receive a packet, the method 300 transfers the packet from the destination FIFO to the output in a step 380. Next, the method 300 then returns to determine whether to process another input or process another output in the decisional step 304.

One skilled in the art should know that the present invention is not limited to processing one input and one output, and then sequentially. The present invention and method may process any number of packets, inputs and outputs, and in a multitasking manner or employ multi-thread capability to process asynchronously. Also, other embodiments of the present invention may have additional or fewer steps than described above.

Although the present invention has been described in detail, those skilled in the art should understand that they can make various changes, substitutions and alterations herein without departing from the spirit and scope of the invention in its broadest form.

What is claimed is:

1. A non-blocking crossbar, comprising:
n inputs, n numbering at least two;
n outputs, each of said outputs having a destination first-in, first-out buffer (FIFO) and n crossbar FIFOs interposing corresponding ones of said n inputs and said destination FIFO; and
a scheduler configured to cause a packet to be transmitted from one of said inputs toward one of said outputs only when both said destination FIFO associated therewith and an interposing one of said crossbar FIFOs are available to contain said packet.

2. The non-blocking crossbar as recited in claim 1 wherein said scheduler is further configured to select one of said inputs based upon a priority thereof.

3. The non-blocking crossbar as recited in claim 1 wherein said scheduler is further configured to select one of said outputs based upon a priority thereof.

4. The non-blocking crossbar as recited in claim 1 wherein at least two of said n inputs are coupled to different types of packet based fabrics.

5. The non-blocking crossbar as recited in claim 1 wherein said first input and said first output is coupled to a SONET network, said second input and said second output is coupled to a Gigabit Ethernet network, and said third input and said third output is coupled to another Gigabit Ethernet network.

6. The non-blocking crossbar as recited in claim 1 wherein each of said outputs further comprises an output arbiter configured to select one of said crossbar FIFOs and transfer a packet therein to said destination FIFO.

7. The non-blocking crossbar as recited in claim 6 wherein said output arbiter is further configured to select said one of said crossbar FIFOs based upon packet priority.

8. A method of operating a non-blocking crossbar, comprising:
employing n inputs, n numbering at least two;
employing n outputs, each of said outputs having a destination first-in, first-out buffer (FIFO) and n crossbar FIFOs interposing corresponding ones of said n inputs and said destination FIFO; and
scheduling a packet to be transmitted from one of said inputs toward one of said outputs only when both said destination FIFO associated therewith and an interposing one of said crossbar FIFOs are available to contain said packet.

9. The method as recited in claim 8 wherein said scheduling further comprises selecting one of said inputs based upon a priority thereof.

10. The method as recited in claim 8 wherein said scheduling further comprises selecting one of said outputs based upon a priority thereof.

11. The method as recited in claim 8 wherein at least two of said n inputs are coupled to different types of packet based fabrics.

12. The method as recited in claim 8 wherein said first input and said first output is coupled to a SONET network, said second input and said second output is coupled to a Gigabit Ethernet network, and said third input and said third output is coupled to another Gigabit Ethernet network.

13. The method as recited in claim 8 further comprising selecting one of said crossbar FIFOs and transfering a packet therein to said destination FIFO.

14. The method as recited in claim 13 wherein said selecting further comprises selecting said one of said crossbar FIFOs based upon packet priority.

15. A multi-channel network line card for packet based networks, comprising:
n physical interfaces, n numbering at least three;
n network processors that converts a packet between protocols, each of said network processors coupled to corresponding ones of said n physical interfaces; and
a non-blocking crossbar coupled to said network processors and said physical interfaces, including:
n inputs that receive said packet from corresponding ones of said n network processors,
n outputs that transmit said packet to corresponding ones of said n physical interfaces, each of said outputs having a destination first-in, first-out buffer (FIFO) and n crossbar FIFOs interposing corresponding ones of said n inputs and said destination FIFO, and
a scheduler that causes said packet to be transmitted from one of said inputs toward one of said outputs only when both said destination FIFO associated therewith and an interposing one of said crossbar FIFOs are available to contain said packet.

16. The multi-channel network line card as recited in claim 15 wherein said network processors further include:
a fast pattern processor that receives said packet from corresponding ones of said n physical interfaces, said fast pattern processor analyzes and classifies said packet; and
a routing switch processor that process said packet classified by said fast pattern processor, performs traffic management and converts said packet into an appropriate network protocol.

17. The multi-channel network line card as recited in claim 15 wherein said scheduler selects one of said inputs based upon a priority thereof and selects one of said outputs based upon a priority thereof.

18. The multi-channel network line card as recited in claim 15 wherein at least two of said n inputs are coupled to different types of packet based networks.

19. The multi-channel network line card as recited in claim 15 wherein said first physical interface is coupled to a SONET network, said second physical interface is coupled to a Gigabit Ethernet network, and said third physical interface is coupled to another Gigabit Ethernet network.

20. The multi-channel network line card as recited in claim 15 wherein each of said outputs further comprises an output arbiter configured to select one of said crossbar FIFOs based upon packet priority and transfer a packet therein to said destination FIFO.
